(19) United States
(12) Patent Application Publication
(10) Pub. No.: US 2019/0184946 A1
(43) Pub. Date: Jun. 20, 2019

(54) SYSTEM AND METHOD FOR VEHICLE CARE, AND USE OF A SYSTEM OF THIS TYPE

(71) Applicant: Alfred Kärcher SE & Co. KG, Winnenden (DE)

(72) Inventors: Andreas Friederich, Backnang (DE); Henning Hayn, Stuttgart (DE); Benjamin Kutz, Sersheim (DE); Michael Schechterle, Murrhardt (DE)

(21) Appl. No.: 16/265,184

(22) Filed: Feb. 1, 2019

Related U.S. Application Data
(63) Continuation of application No. PCT/EP2016/068683, filed on Aug. 4, 2016.

(51) Int. Cl. B60S 3/00; G05D 1/02; B60S 5/02; B60S 5/06; G07C 5/08

(52) U.S. Cl. CPC B60S 3/008; G05D 1/021; B60S 5/02; B60L 53/00; G07C 5/0808; G05D 2201/0213; B60S 5/06

(57) ABSTRACT

A system for vehicle care and in particular vehicle cleaning is provided, including at least one vehicle care device and a control device, wherein vehicles can be brought to the at least one vehicle care device and can be removed therefrom, and the control device is configured for communication with non-user-guided vehicles, wherein at least one vehicle care instruction including information about the care of the vehicle and associated with a particular vehicle can be stored in the control device, and the vehicles can be treated at the at least one vehicle care device according to the at least one vehicle care instruction, and wherein the sequence of processing of vehicle care instructions and/or the scope of the vehicle care stored in at least one vehicle care instruction can be changed by the control device. The invention additionally relates to a method for vehicle care.

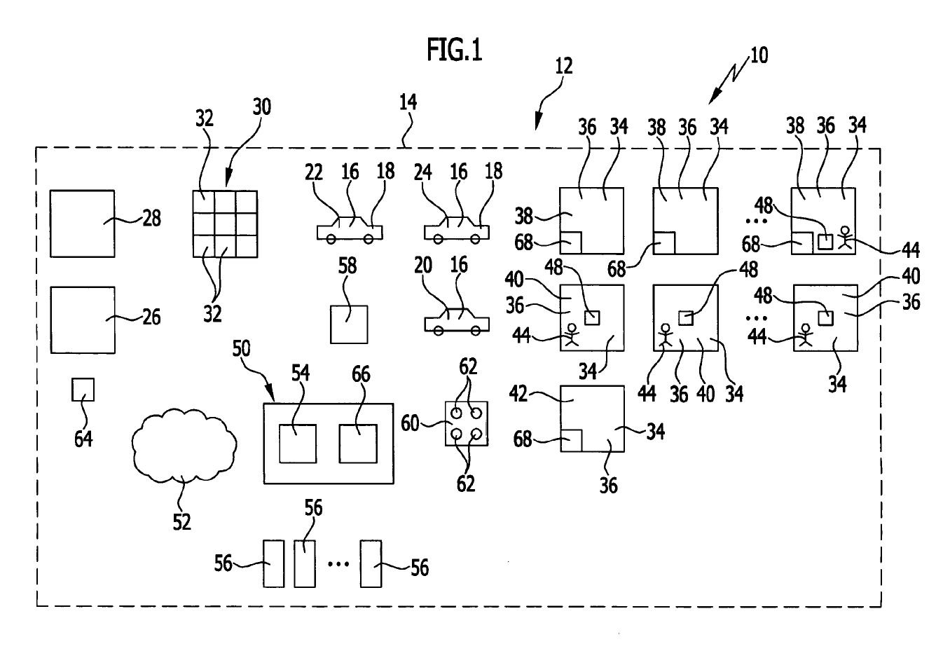

### CROSS-REFERENCE TO RELATED APPLICATIONS

This application is a continuation patent application of international application number PCT/EP2016/068683, filed on Aug. 4, 2016 which is incorporated herein by reference in its entirety and for all purposes.

### FIELD OF THE INVENTION

The present invention relates to a system for vehicle care and in particular vehicle cleaning, comprising at least one vehicle care device and a control device, wherein vehicles can be brought to the at least one vehicle care device and can be removed therefrom, and the control device is configured for communication with non-user-guided vehicles.

The present invention additionally relates to a method for vehicle care with use of a system of this type.

The present invention also relates to a use of a system of this type, for example at a vehicle rental location or at a service station.

### BACKGROUND OF THE INVENTION

A system of the above-mentioned type allows the care of vehicles, wherein the term “care” in the present case can be understood to mean in particular the cleaning of the vehicles externally and/or internally and the replenishment, replacement or drainage of an operating material (for example fuel, screen wash, oil, air, battery power, etc.) or replacement part (for example a filter, battery, etc.) for the vehicle.

DE 103 22 765 A1 describes an automated haulage yard for heavy goods vehicles. Vehicles transferred to the haulage yard, under control of a control device, are firstly brought to an unloading station, then to a refueling station, and before being transferred to a vehicle driver are brought to a loading station. As required, and determinable at the time of receipt of the vehicle at the haulage yard, vehicles are driven after unloading to a washing station and are cleaned there, before they are brought to the refueling station. The method described in DE 103 22 765 A1 is subject to considerable limitations in practice.

Due to the long residence time of the heavy goods vehicles in the unloading station, the washing station and the refueling station, the method is suitable only for relatively small throughput quantities. At a higher volume the receiving alone of heavy goods vehicles at the haulage yard can lead to long waiting times and, as a result, to congestion.

DE 10 2012 016 039 A1 describes a car wash into which a vehicle can drive autonomously. Information regarding the control of the vehicle is transferred from the car wash to the vehicle.

DE 10 2014 224 124 A1 describes a method for operating a vehicle in which the vehicle, after arrival at an accessible infrastructure, registers with an infrastructure management server for the infrastructure. The vehicle receives data from the infrastructure management server, on the basis of which data the vehicle travels through the infrastructure from a starting position to a target position.

An object underlying the present invention is to provide a system and a method for vehicle care and also the use of a system, wherein said system and method make it possible to carry out vehicle care efficiently.

### SUMMARY OF THE INVENTION

In a first aspect of the invention, a system for vehicle care and in particular vehicle cleaning is provided, comprising at least one vehicle care device and a control device. Vehicles are movable to the at least one vehicle care device and are removable therefrom, and the control device is configured for communication with non-user-guided vehicles. There is storable in the control device associated with a particular vehicle at least one vehicle care instruction comprising information about the care of the vehicle, and the vehicles are treatable at the at least one vehicle care device according to the at least one vehicle care instruction. The sequence of processing of vehicle care instructions and/or the scope of the vehicle care stored in at least one vehicle care instruction is changeable by the control device.

In a second aspect of the invention, a system in accordance with the first aspect is used at a vehicle rental location, a car dealership, a service station, a vehicle cleaning station, a parking station, a car-sharing station, a company vehicle station or fleet, or a gas station.

In a third aspect of the invention, a method for vehicle care using a system in accordance with the first aspect is provided, in which at least one vehicle care instruction associated with a particular vehicle and comprising information about the care of a vehicle is storable in the control device. The vehicles are brought to the at least one vehicle care device depending on the at least one vehicle care instruction, receive care at said vehicle care device in accordance with the vehicle care instruction, and are removed from said vehicle care device. The sequence of processing of vehicle care instructions and/or the scope of the vehicle care stored in at least one vehicle care instruction is changeable by the control device.

### BRIEF DESCRIPTION OF THE DRAWING

The foregoing summary and the following description may be better understood in conjunction with the sole drawing FIGURE which schematically shows an advantageous embodiment, denoted by reference numeral 10, of a system according to the invention.

### DETAILED DESCRIPTION OF PREFERRED EMBODIMENTS OF THE INVENTION

Although the invention is illustrated and described herein with reference to a specific embodiment, the invention is not intended to be limited to the details show. Rather, various modifications may be made in the details with the scope and range of equivalents of the claims and without departing from the invention.

The present invention relates to a system for vehicle care and in particular vehicle cleaning, comprising at least one vehicle care device and a control device, wherein vehicles are movable to the at least one vehicle care device and are removable therefrom and the control device is configured for communication with non-user-guided vehicles, wherein there is stored in the control device associated with a particular vehicle, at least one vehicle care instruction comprising information about the care of the vehicle, and the vehicles are treatable at the at least one vehicle care device according to the at least one vehicle care instruction, and wherein the sequence of processing of vehicle care instructions and/or the scope of the vehicle care stored in at least one vehicle care instruction is changeable by the control device.

In the system according to the invention it is possible, by means of the control device, to change the sequence in which the vehicle care instructions associated with the various vehicles are processed. In the system according to the invention, by adjusting the sequence of the vehicle care instructions, it is possible to react flexibly to current states of the at least one vehicle care device, such as the capacity utilization thereof (for example in the case of a plurality of vehicle care devices), different vehicle care durations, and different numbers of vehicles requiring care (to name just a few exemplary external influences). In contrast to the system described in DE 103 22 765 A1, which provides unchangeable sequential processing of washing instructions and refueling instructions, efficient processing of the vehicle care instructions is thus made possible.

Alternatively or additionally, in the system according to the invention it is possible to change the scopes of the vehicle care stored in at least one vehicle care instruction. The scope of the vehicle care stored in a vehicle care instruction, also referred to hereinafter as the “scope of the vehicle care” for short, can include in particular one of the following items of information: type of vehicle care for a specific vehicle, intensity of the vehicle care, duration of the vehicle care, details regarding the amount and/or nature of operating materials and/or replacement parts, employment of auxiliary devices or tools when providing the vehicle care. If, for example, a device for vehicle cleaning is provided as vehicle care device, the scope of the vehicle care may comprise information about the intensity of the cleaning, the duration of the cleaning, the employment of a cleaning tool and/or, in vehicle washing facilities, the specification of a cleaning program, for example. The possibility to change the scope of the vehicle care makes the system highly versatile. For example at peak times, when a high number of vehicles require care, the scopes of the vehicle care of selected or all vehicles can be reduced, thus shortening the throughput time for vehicles through the at least one vehicle care device. Conversely, when numbers are low the scope of the vehicle care can be increased, advantageously, and improved vehicle care can be provided.

It is preferably possible by means of the control device to change the sequence of processing of all vehicle care instructions and/or the scope of the vehicle care of all vehicle care instructions. It goes without saying that the scopes of the vehicle care of different vehicle care instructions can be different from one another.

The control device is configured for communication with non-user-guided vehicles, which are movable in a self-driving and self-steering manner, i.e. autonomously, or under remote control by the control device. With regard to efficient execution of the vehicle care and without the need of a driver for such vehicles, the control device can thus changeably coordinate the vehicle care instructions to be coordinated with these vehicles such that the vehicles are brought to a particular vehicle care device at an optimal time, are treated in accordance with the vehicle care instruction, and are removed or driven away from said vehicle care device once the vehicle care is complete.

The invention incorporates the consideration that facilities comprising a system of this kind for vehicle care may be faced with a high number of vehicles to be managed and requiring care. An example of a facility of this kind is a vehicle rental location. Vehicle rental locations for example at airports with high passenger volumes manage a high number of vehicles which are returned or picked up by vehicle renters at different times, wherein great fluctuations can occur depending on the time of day and/or day of the week, but for example also when public transport is disrupted. The vehicles require care once they have been received and before they are rented out again, in particular they require cleaning and/or refueling. Since the residence time of the vehicles at the vehicle rental location should be as short as possible in order to maximize profits, efficient processing of the vehicle care instructions is necessary. This is complicated by the fact that the return of expected and already scheduled vehicles may be cancelled, resulting in a (even short-term) different need for vehicles of different types. Throughput times must therefore be minimized and the vehicle care optimized. The use of the system according to the invention at a vehicle rental location is merely exemplary, however, and said system, and equally the method according to the invention and the use according to the invention, is also suitable for employment elsewhere, where the care of vehicles at the at least one vehicle care device needs to be coordinated by a control device.

In an advantageous embodiment a plurality of vehicle care devices can be provided, wherein vehicles may be associated with more than one vehicle care instruction for care at a corresponding vehicle care device. At least some of the vehicles can be linked to more than one vehicle care instruction, for example cleaning, refueling or battery charging, oil change, etc.

The sequence of processing of a plurality of vehicle care instructions associated with a vehicle and/or the sequence of processing of vehicle care instructions associated with different vehicles is advantageously changeable by the control device. If, for example, a plurality of vehicle care devices of different type is provided (this will be explained in greater detail), the control device can efficiently coordinate vehicle care instructions and control the processing thereof. If a plurality of vehicle care instructions is provided for a single vehicle, the control device can preferably allow one vehicle care instruction to be performed at an available vehicle care device and for example can give it priority over a previously scheduled vehicle care instruction at a further vehicle care device, should that further device not be available.

It is favorable if the sequence of processing of vehicle care instructions is changeable by an operator of the system by means of a data processing apparatus. An operator, for example a supervisor, can change the sequence of processing of the vehicle care instructions alternatively or additionally to the control device, with regard to providing optimized vehicle care. The operator can manage a data processing apparatus for the control device, for example a terminal, computer or a website. In particular, the employment of a data processing apparatus that in particular is portable, for example a tablet, laptop or a smartphone, is also conceivable.

It is favorable if the sequence of processing of vehicle care instructions is definable by the control device and/or by an operator of the system. For example, the sequence of processing is defined initially as vehicles are received at a facility comprising the system. The possibility of defining the sequence by the control device and/or an operator lends the system a high level of versatility.

A scope of the vehicle care stored in at least one vehicle care instruction is advantageously changeable by an operator of the system. The scopes of the vehicle care of all vehicle care instructions are preferably changeable by the operator.

Accordingly, it is preferably made possible for a scope relating to a cleaning of the vehicle to be changed by the control device and/or by an operator.

In an advantageous embodiment of the system at least one device for vehicle cleaning is provided as vehicle care device. A plurality of devices for vehicle cleaning is advantageously provided.

The device for vehicle cleaning in a preferred embodiment of the invention may be or may comprise a vehicle washing facility. The vehicle washing facility may be configured as a gantry washing facility or as an automated car wash. A plurality of gantry washing facilities and/or a plurality of automated car washes may be provided.

Alternatively or additionally, the device for vehicle cleaning may be or may comprise an interior cleaning device for cleaning a vehicle interior.

In an advantageous embodiment the device for vehicle cleaning may have at least one cleaning tool managed by an operator, or such a tool may be arranged on said device. The operator can clean the vehicle with use of the cleaning tool. The cleaning tool may be or may comprise for example a washing tool, a suction cleaning tool, or a wiper tool. For example, a high-pressure cleaning apparatus is provided for manual cleaning by the operator.

Alternatively or additionally, a device for replenishing, changing and/or draining an operating material or replacement part of the vehicle can be provided. A device of this kind may be in particular a refueling device for the vehicle. A battery charging device or replacing device for a vehicle battery is also conceivable. An operating material is understood in the present case for example to mean fuel, screen wash, oil, battery power, air or a gas for filling vehicle tires.

It is favorable if at least one vehicle care device is configured to provide autonomous care for the vehicle, at least in part. This provides the possibility of providing the vehicle care without input from an operator. Care can be provided for the vehicle automatically by the vehicle care device. It is conceivable that the vehicle care device starts and/or ends the vehicle care automatically, following the arrival of the vehicle at the vehicle care device and completion of the care process. The term “autonomous care” however can also be understood in the present context to mean that the care process is initiated by an operator and/or ended by an operator, but otherwise is performed automatically by the vehicle care device.

The vehicle care device can receive information from the control device for starting the vehicle care and/or ending said vehicle care. The vehicle care device can transmit information about the status of the vehicle care to the control device. The control device may be part of a control unit arranged on or in the vehicle care device.

Autonomous vehicle care preferably can be carried out by means of a device for vehicle cleaning, in particular a vehicle washing facility.

In another advantageous embodiment of the system it is favorable if the vehicle care device is configured in such a way that vehicle care is provided at least in part with employment of an operator. This is possible for example in the case of a cleaning device where an operator employs a cleaning tool for interior or exterior cleaning. Refueling or battery charging by an operator is also conceivable.

It is advantageous if the sequence of processing of the vehicle care instructions and/or the scope of the vehicle care instructions at least at one vehicle care device is determined or changed by the control device with regard to a high throughput of vehicles. The sequence of processing and/or the scope of the vehicle care instructions can be optimized by the control device such that a maximum number of vehicles per unit of time receive care at least at one vehicle care device, and preferably at all vehicle care devices. For this purpose, the control device in particular can utilize information as to how many vehicles and the type of care required thereby must be considered at any moment in time, and can preferably take into consideration the respective care durations and/or the capacity utilization of vehicle care devices.

It is advantageous if the sequence of processing of vehicle care instructions and/or the scope of vehicle care instructions at least at one vehicle care device is determined or changed by the control device with regard to at least one of the following:
short waiting time for a vehicle at the vehicle care device before receiving the vehicle care, so as to avoid congestion at said device;
bringing vehicles to vehicle care devices with minimal congestion, so as to keep free any routes for the vehicles at a facility comprising the system;
guiding vehicles away from the vehicle care device with minimal congestion, so as to likewise attain the last-mentioned advantage.

In the system, user-guided vehicles can preferably also receive care. The transport of vehicles to the vehicle care device and/or the removal of vehicles from said vehicle care device with little congestion and also a minimal waiting time have proven to be particularly advantageous for an efficient employment of staff. Excessive waiting times and therefore a waste of working time for operator staff can thus be avoided as far as possible.

It is advantageous if the sequence of processing of the vehicle care instructions and/or the scope of the vehicle care stored in a vehicle care instruction is determined or changed by the control device on the basis of the vehicle care instruction in respect of the result of the vehicle care. For example, the scope of the vehicle care can be reduced in order to reduce the throughput time of vehicles or can be increased in order to optimize the vehicle care. This can prove to be advantageous in particular in the case of vehicle cleaning.

At least one of the following can be determined or changed by the control device depending on information that is suppliable to the control device or that is determinable thereby automatically:
the sequence of processing of the vehicle care instructions;
the scope of the vehicle care stored in a vehicle care instruction;
times of the processing of vehicle care instructions;
the allocation of a particular vehicle care instruction to a specific vehicle care device, provided a plurality of vehicle care devices of the same type or kind is provided, for example a plurality of vehicle washing facilities or a plurality of refueling devices.

The different types of information that are suppliable by the control device or that are determinable automatically thereby and that, either individually or in combination with at least one of the further items of information described hereinafter, can initiate one of the above-mentioned actions of the control device will be discussed below.

The information can be or can comprise details about the nature of the vehicle as user-guided vehicle or non-user-guided vehicle.

The information can comprise the anticipated time of arrival of the vehicle at a facility having the system.

The information can comprise the actual time of arrival of a vehicle at a facility having the system.

The information can be or can comprise the anticipated time of arrival of a vehicle at the at least one vehicle care device, wherein time required for bringing the vehicle from a parking space to the vehicle care device can be taken into consideration, for example.

The information can be or can comprise the actual time of arrival of a vehicle at the at least one vehicle care device.

The information can be or can comprise the anticipated and/or actual number of vehicles requiring care.

The information can be or can comprise the anticipated and/or actual duration of the processing of a vehicle care instruction at the at least one vehicle care device and/or at least at one vehicle care device.

The information can be or can comprise the capacity utilization of the at least one vehicle care device.

The information can be or can comprise the day of the week of scheduled or performed vehicle care, wherein the scope of the vehicle care instructions can be reducible, preferably at peak times. In order to ensure at peak times that the vehicle care instructions are fulfilled, it can be provided for the scope of the vehicle care to be changeable by the control device.

The information can be or can comprise the time of day of scheduled or performed vehicle care, wherein the scope of the vehicle care instructions is reducible, preferably at peak times.

Peak times may be in particular Monday morning and Friday afternoon or Friday evening, for example in the case of a vehicle rental location comprising the system.

The information can be or can comprise holiday times or non-holiday times.

The information can be or can comprise requirements with regard to working hours of operator staff. In this regard it is favorable if the care of user-guided vehicles can be provided during the day, for example during normal working hours. By contrast, the care of non-user-guided vehicles can also be practicable at night-time. This also reduces staffing costs. Alternatively or additionally, a vehicle care device that utilizes an operator is advantageously used during the day, for example during normal working hours, and an autonomous vehicle care device is also usable at night-time.

The information can be or can comprise requirements with regard to operating times of the at least one vehicle care device, for example with respect to noise protection.

The information can be or can comprise costs for energy and consumables, in particular water, which are necessary for the operation of the at least one vehicle care device. The vehicle care is preferably performed at times when the costs are lower.

The information can be or can comprise information about notifications during the processing of vehicle care instructions, said notifications being transmitted to the control device from the vehicle care device or from an operator to the vehicle care device. For example, status notifications relating to the processing of vehicle care instructions are transmitted to the control device.

Information can be or can comprise information about any servicing or maintenance times or faults of the at least one vehicle care device. Should a vehicle care device be placed out of service, the control device can preferably assign vehicle care instructions to another vehicle care device.

The information can be or can comprise information about any disruptions to or limitations of the operation of the public transport network (for example as a result of strikes). In the case of disruptions, an increased vehicle demand may be anticipated for example in a vehicle rental location, and therefore the processing of the vehicle care instructions is adapted.

The information can be or can comprise information regarding strikes or other absences (for example caused by illness) of operator staff of vehicles or the at least one vehicle care device. For example, if driving staff for user-guided vehicles go on strike, the control device can prioritize vehicle care instructions for non-user-guided vehicles.

In an advantageous embodiment of the system it is favorable if a device for vehicle cleaning is provided as vehicle care device and if the sequence of processing of the vehicle care instructions and/or the vehicle cleaning extent are/is determined with regard to basic or fundamental cleaning of the vehicles or with regard to a maximum cleaning performance. In this embodiment the scope of the vehicle cleaning is the “scope of the vehicle care”.

It is favorable if a device for vehicle cleaning is provided as a vehicle care device and if a cleaning need for the vehicle can be determined with regard to storing a scope of the vehicle cleaning in the vehicle care instruction for need-dependent cleaning of the vehicle. By estimating the cleaning need, the necessary scope of the vehicle cleaning can be stored in the vehicle care instruction in order to optimize the processing of vehicle cleaning instructions. For example, vehicle cleaning can be performed only to the necessary extent, and therefore the duration of the vehicle care can be minimized, and resources can be saved.

The system advantageously has a recording device for vehicles which in particular comprises at least one camera, and the cleaning need is preferably determinable by the control device depending on a signal of the recording device. This makes it possible to automatically ascertain the cleaning need, without the input of a user. The vehicle is recorded by the recording device for example during the transfer. For example, at least one camera is used here in order to optically determine the vehicle state and provide a signal in this regard to the control device.

It is alternatively or additionally favorable if the cleaning need is determinable by the control device depending on at least one of the following:
vehicle type;
vehicle age;
time since the vehicle was last cleaned;
distance travelled since the vehicle was last cleaned;

and/or, in particular in the case of rental vehicles,
weather at the location of use, rental or return of the vehicle;
road conditions at the location of use, rental or return of the vehicle;
previous rental duration;
next scheduled rental duration;
last vehicle renter;
next vehicle renter;
status of the last or next vehicle renter as preferred or less preferred customer. A “preferred” customer can be considered for example to be one who returns vehicles in a cleaner state or to whom a cleaner vehicle is preferably given. A “less preferred” customer is for example a vehicle user who is known to return vehicles in a dirtier state.

It is favorable if the cleaning need is determinable by an operator and is transmittable to the control device by means of a data processing apparatus, or if the extent of vehicle cleaning is changeable in the vehicle care instruction. This in particular makes it possible to automatically ascertain the cleaning need in accordance with one of the above-mentioned methods and, by way of precaution, to additionally perform a check by an operator.

The vehicle care instruction can comprise the information that cleaning is not necessary if no sufficient need for this is demonstrable or if the establishment of a vehicle care instruction lapses in this case.

The control device is advantageously configured for communication with autonomous vehicles, wherein these are movable under control of the control device. Vehicles that are “autonomous” are understood to be vehicles that are configured to be self-driving and self-steering. The vehicles can include information about a facility comprising the system, such that they can drive autonomously from a starting position to a target position. Autonomously driving vehicles can preferably drive automatically into the at least one vehicle care device and/or away therefrom. The control device can automatically identify autonomous vehicles, or these can be revealed as such to the control device.

It is advantageous if the control device is configured for communication with remote-controllable vehicles, wherein these are movable under control of the control device. Vehicles that are “remote-controllable” are understood in the present case in particular to be vehicles that can execute control commands of the control device in order to control actuators, such as drive, steering and braking. Remote-controllable vehicles can be identified automatically by the control device or can identify themselves to the control device.

The control device can preferably transmit information to autonomous and/or remote-controllable vehicles.

The system expediently has data-processing apparatuses for operator staff by means of which non-user-guided vehicles can be guided by the operator. It is conceivable that vehicles that are autonomous per se or that can be controlled remotely can still be guided by an operator. The operator can transmit control commands for guiding the vehicle by means of a data processing apparatus, for example a smartphone or tablet.

It is advantageous if the control device is configured for communication with external data-processing apparatuses managed by the operator or arranged in the vehicles in order to transmit instructions for executing the vehicle care instructions with employment of an operator, in particular for guiding user-guided vehicles. Operator staff for example can carry portable data processing apparatuses with them, for example a smartphone or a tablet. The control device of the operator can receive information for processing a vehicle care instruction by means of the data processing apparatus. By way of example, the information for guiding a user-guided vehicle relates for example to the time and location of the vehicle care. Alternatively or additionally, data-processing apparatuses can be arranged in the user-guided vehicles and for example can be fixedly installed therein.

In an advantageous embodiment the system may have at least one transport device, by means of which a vehicle is movable to and/or is collectable from at least one vehicle care device, wherein the at least one transport device is in communication with the control device and is controllable thereby. For example, a vehicle is picked up from a parking space by means of the at least one transport device and is brought to the vehicle care device. It is conceivable that the vehicle remains on the transport device during the vehicle care or is unloaded therefrom for the purpose of the vehicle care. The vehicle can be picked up by the at least one transport device following the vehicle care and can be removed from the vehicle care device and for example parked in a parking space.

It is favorable if the system comprises a detection device coupled to the control device for determining a vehicle position. In particular there is the possibility to determine where a particular vehicle is currently located. Position information can be taken into consideration by the control device when planning the vehicle care instructions.

The detection device preferably has sensor elements for detecting the vehicles, preferably contactlessly. For example, the vehicles can be detected optically.

The sensor elements advantageously are, or comprise cameras, by means of which the vehicles, the registration numbers thereof and/or other characterizing elements comprised by the vehicles are optically detectable. Other types of characterizing elements are for example coded stickers, badges or the like, which are arranged on the vehicles and enable the vehicles to be identified in particular individually. For example, barcodes or matrix codes can be used as codes.

Alternatively or additionally, the sensor elements can be or can comprise wireless elements for locating vehicles by wireless connection, for example by means of RFID technology or Bluetooth technology.

It is advantageous if the detection device and/or the control device is in communication with position-determining elements arranged in the vehicles. For example, vehicles have position-determining elements, on the basis of which the position of the vehicles can be found. Here, the use of an absolute reference system (for example with GPS information) and/or of a relative reference system (for example position within a facility comprising the system) is possible. The vehicles can provide position information to the control device.

In an advantageous embodiment the control device may comprise a vehicle control unit and a planning unit, wherein the vehicle control unit is configured for communication with non-user-guided vehicles and vehicle care instructions are configured to be coordinated by the planning unit, wherein the planning unit is in communication with at least one control unit, which is associated with the at least one vehicle care device or is comprised thereby, in order to transmit vehicle care instructions to the at least one control unit and/or to receive status notifications regarding the at least one vehicle care device by the at least one control unit. For example, non-user-guided vehicles are brought to and/or removed from the vehicle care device under control of the vehicle control unit. A vehicle care instruction for the at least one vehicle care device can be transmitted to the control unit thereof. The processing can be initiated by the control unit. The control unit can transmit status information or status messages to the planning unit. Each vehicle care device can be associated with its own control unit.

The control device does not need to be spatially limited in the present case and is therefore not necessarily equated with a (single) data processing device, although this is possible.

In the present case, a central control device or a spatially distributed control device having a plurality of data processing units can be provided. The control device can use or can be formed from a plurality of data processing units, which can be arranged in various locations. The data processing units can be linked to one another in a wired manner and/or wirelessly. It is possible to outsource the control device partially or completely in what is known as a “cloud”. Data processing units of the control device can be arranged in vehicle care devices or comprised thereby, for example the above-mentioned control units. Data processing units of the control device can be arranged in vehicles or comprised thereby. Said vehicles can each contain, stored therein, information relating to care instructions associated with them.

The control device can be formed by at least one data processing unit or can comprise such a unit. A data processing unit of this kind for example comprises a microprocessor, by which a computer program of the data processing unit can be run. The computer program comprises particular algorithms for establishing, managing and coordinating vehicle care instructions.

The control device, or part thereof, can comprise at least one memory unit, in which information about the vehicles is stored. Vehicle care instructions can be stored in the at least one memory unit. A common memory unit for a plurality of data processing units can be provided. The memory unit can be arranged separately from the data processing units.

The above-mentioned vehicle control unit and/or the above-mentioned planning unit can be comprised or formed by the same data processing unit. It is also possible to spatially separate the vehicle control unit and the planning unit. The vehicle control unit and the planning unit can be implemented by different computer programs of the control device.

The control device can comprise at least one communication member for communicating with vehicles and/or the at least one vehicle care device.

A report can be established expediently by the control device regarding scheduled and/or performed vehicle care instructions. The report can be established in physical form, for example by being printed out, and/or digitally. The report can be transmitted to further data-processing units, such as data-processing apparatuses (Internet server, tablet, laptop, smartphone, etc.). Information about disturbances in the operating sequence can be contained in the report, for example information regarding a fault of the at least one vehicle care device. The report can contain billing information or can be formed as such, said information being intended for a billing device of the system. Invoicing can thus be facilitated.

The system preferably comprises at least one transfer device for receiving of the vehicle by the system from a vehicle user and/or for transfer of the vehicle from the system to a vehicle user. The respective transfer can be executable with the aid of an operator or without an operator.

The system preferably comprises an area in which there are arranged at least the at least one vehicle care device and parking spaces for vehicles for the temporary parking of vehicles. It can be provided that vehicles are parked in a parking space before and/or after the processing of a vehicle care instruction, as appropriate between the processing of successive vehicle care instructions.

As mentioned at the outset, the present invention also relates to a use. A use according to the invention includes the use of a system of the above-mentioned type at a vehicle rental location, a car dealership, a service station, a vehicle cleaning station, a parking station, a car-sharing station, a company vehicle station or fleet, or a gas station.

A method according to the invention for achieving the object described at the outset uses a system of the above-described type, in which at least one vehicle care instruction associated with a particular vehicle and comprising information about the care of the vehicle is storable in the control device, and the vehicles are brought to the at least one vehicle care device depending on the at least one vehicle care instruction, receive care at said vehicle care device in accordance with the vehicle care instruction, and are removed from said vehicle care device, wherein the sequence of the processing of vehicle care instructions and/or the scope of the vehicle care stored in at least one vehicle care instruction are/is changeable by the control device.

The advantages already mentioned in conjunction with the explanation of the system according to the invention can likewise be attained with the use according to the invention and with the method according to the invention. In this regard, reference can be made to the comments provided above. The same applies to advantageous exemplary embodiments of the use according to the invention and the method according to the invention, wherein, with regard to the definition thereof, reference can be made to advantageous embodiments of the system according to the invention.

The following description of an advantageous embodiment of the invention serves in conjunction with the sole FIGURE of the drawing to explain the invention in greater detail. An advantageous embodiment of a system according to the invention with which the method according to the invention can be carried out is described. The use of the system according to the invention is also described.

The system 10 shown therein can be employed in the case of a use according to the invention at a vehicle rental location 12. The vehicle rental location 12 is a facility comprising the system 10, said facility having an area 14.

Vehicles 16 are received at, and handed over from, the vehicle rental location 12. The vehicles 16 are generally configured differently, there being different vehicle types which can differ from one another in particular in respect of the vehicle class or size (small vehicle, compact vehicle, medium class vehicle, luxury class vehicle, etc.) and/or in respect of the vehicle design (sedan, station wagon, roadster, cabriolet, people carrier, etc.). The vehicles 16 may additionally differ from one another in respect of their functionality. In the present case, a distinction can be made for example between non-user-guided vehicles 18 and user-guided vehicles 20.

In the case of the non-user-guided vehicles 18, a distinction can be made in the present case for example between autonomous vehicles 22, which are configured to be self-driving and self-steering, and remote-controllable vehicles 24. Remote-controllable vehicles 24 can receive control commands and can convert these into the control of a drive and a steering system. In the present case, a user-guided vehicle 20, an autonomous vehicle 22, and a remote-controllable vehicle 24 are shown by way of example. It goes without saying that a large number of vehicles 16 are generally disposed within the area 14.

The system 10 comprises a first transfer device 26, where previously rented vehicles are returned by vehicle renters and can be received by the system 10. In addition, the system 10 has a second transfer device 28, where rented vehicles can be delivered to new vehicle renters.

Different routes (not shown) for vehicles 16 can be provided within the area 14, so that said vehicles can be moved within the region of the area 14 in ways yet to be explained.

In order to park vehicles 16 temporarily, the system 10 has a parking device 30 with a plurality of parking spaces 32 for vehicles 16. The parking spaces, as shown schematically in the drawing, can be arranged side by side. A spatially separated arrangement and in particular distribution over the region of the area 14 is also conceivable.

The system 10 has vehicle care devices 34. Vehicle care stored in a vehicle care instruction can be performed for a particular vehicle 16 at a particular vehicle care device 34. A plurality of vehicle care instructions can be associated with each vehicle 16 for vehicle care at a plurality of vehicle care devices 34.

In the present case the vehicle care devices 34 comprise devices for vehicle cleaning 36, more specifically vehicle washing facilities 38 and interior cleaning devices 40. In the present case, a refueling device 42 is provided as further vehicle care device 34. A charging device or a replacing device for charging or replacing a battery of a vehicle 16 is also conceivable.

The vehicle washing facilities 38 can be configured as gantry washing facilities or as automated car washes. It is conceivable that the vehicle washing facilities 38 can perform autonomous care and in particular cleaning of vehicles 16, wherein the cleaning operation is initiated automatically once a vehicle 16 has been brought to the vehicle washing facility 38 and is ended automatically. It is also conceivable that the cleaning operation is performed with the additional aid of an operator 44. For example, the operator 44 starts the cleaning program once the vehicle 16 has been positioned at the vehicle washing facility 38.

An operator 44 can at least partially clean, in particular wash, the vehicle externally and/or internally. A pre-cleaning is conceivable in the case of a vehicle washing facility 38, for example with a cleaning tool 48. This tool for example is a washing lance of a high-pressure cleaning apparatus.

The interior cleaning devices 40 serve in the present case to clean a vehicle interior. To this end, operator staff 44 are positioned at the interior cleaning devices 40. Operator staff 44 can use a particular cleaning tool 48 to clean the interior of a vehicle 16. The cleaning tool 48 is for example a suction cleaning tool.

Alternatively, an autonomous interior cleaning device 40 can be provided.

The refueling device 42 makes it possible to refuel vehicles 16. In the present case the fueling device 42 is for example configured autonomously, for autonomous refueling of the vehicles 16.

Alternatively, refueling can be performed by an operator 44.

The system 10 comprises a control device 50. The control device 50 is used to manage and coordinate vehicle care instructions associated with the vehicles 16. The control device 50 can be arranged in the area 14 or spatially separated therefrom, and it can comprise a plurality of data processing units, which are positioned spatially at the same location or at different locations. It is in particular also possible that at least one data processing unit of the control device 50 is arranged in, or comprised by a “cloud” 52 shown in a symbolized manner in the drawing.

In the present case the control device 50 comprises a vehicle control unit 54. The vehicle control unit 54 is configured for communication with non-user-guided vehicles 18. Non-user-guided vehicles 18 can be controlled by the vehicle control unit 54 and thus moved within the area 14. This is true for the autonomous vehicles 22 and the remote-controllable vehicles 24.

In addition, the vehicle control unit 54 can be in communication with data processing apparatuses 56, three of which data processing apparatuses 56 are shown in the drawing by way of example. The data processing apparatuses 56 are preferably portable and for example are configured as smartphones or tablets.

User-guided vehicles 20 can be guided by an operator 44. For this purpose, the vehicle control unit 54 can transmit information relating to the processing of a vehicle care instruction to a data processing apparatus 56 of an operator 44. The operator 44 can move the user-guided vehicle 20 within the area 14 in accordance with the specifications of the vehicle control unit 54. A data processing apparatus 56 can be arranged or installed in the vehicle 16 in question.

It is also conceivable for an operator 44 to guide a non-user-guided vehicle 18.

The system 10 in a preferred embodiment comprises at least one transport device 58, by means of which a vehicle 16 can be transported within the area 14, in particular is movable to and/or collectable from a vehicle care device 34. The control device 50, in particular the vehicle control unit 54 thereof, is configured for communication with the transport device 58. The transport device 58 can receive a determinable vehicle 16 and move it, in the way that is predefined, within the area 14 under control of the control device 50.

The system 10 comprises a detection device 60 determining the position of vehicles 16 within the area 14. The detection device 60 can comprise a multiplicity of sensor elements 62 shown by way of example. The sensor elements 62 are preferably arranged in a manner spatially distributed (not shown) over the area 14.

The sensor elements 62 make it possible to detect the position of vehicles 16, preferably contactlessly and to send a position signal in this regard to the control device 50. For example, the sensor elements 62 are configured as cameras. The sensor elements 62 can detect the vehicle as a whole, the registration number thereof, and/or another characterizing element, for example a sticker on the vehicle 16 provided with a code.

Alternatively or additionally, the sensor elements 62 can be wireless elements for the radiolocating of vehicles 16, for example by means of RFID technology or Bluetooth technology.

By means of the detection device 60, it is possible for the control device 50 to determine a particular position of a vehicle 16 within the area 14. The control device 50 is thus also able to determine the starting position from which a particular vehicle 16 can be transported to a possible target position. The time required for this can be estimated by the control device 50.

The same objectives can be achieved preferably in that vehicles 16 comprise an integrated position-determining element which is in communication with the control device 50. Vehicles 16 can notify the control device 50 of their current position, so that said control device can thus likewise determine the location within the area 14.

The control device 50 allows vehicle care instructions to be created and coordinated independently or in a manner actuated by an operator 44, said vehicle care instructions being associated with a particular vehicle. The vehicle care instructions are in particular vehicle care instructions for exterior cleaning and interior cleaning by means of the vehicle washing facilities 38 or at the interior cleaning devices 40. Vehicle refueling instructions at the refueling device 42 or charging instructions or replacement instructions for charging or replacing a vehicle battery can also be provided.

In order to establish vehicle cleaning instructions, a recording device 64 for example is provided at the transfer device 26 and is in communication with the control device 50. Cameras (not shown in the drawing) create images of the vehicle 16. The control device 50 can estimate the cleaning need for a specific vehicle 16 on the basis of the images and can establish a vehicle cleaning instruction. The cleaning need can define the scope of the vehicle cleaning as part of the vehicle cleaning instruction.

The cleaning need can also be determinable automatically by the control device 50 on the basis of at least one of the following further pieces of information: vehicle type, vehicle age, time since the vehicle was last cleaned, distance travelled since the vehicle was last cleaned and/or, in particular in the case of rental vehicles, weather at the location of use, rental or return of the vehicle, road conditions at the location of use, rental or return of the vehicle, previous rental duration, next scheduled rental duration, last or next vehicle renter, status of the last or next vehicle renter as preferred or less preferred customer.

An operator 44 can alternatively or additionally determine the cleaning need in particular on the basis of the actual degree of soiling and can specify to the control device 50 the extent of the vehicle cleaning instruction, for example by means of a data processing apparatus 56.

Vehicle care instructions can be established, managed and coordinated for example by a planning unit 66 of the control device 50.

The control device 50 coordinates the processing of the cleaning instructions and any refueling instructions, preferably with regard to at least one of the following:
a high throughput of vehicles 16 at least at one of the vehicle care devices 34;
a short waiting time for vehicles 16 at a particular vehicle care device 34 before the cleaning or the refueling is performed;
bringing vehicles 16 to a particular vehicle care device 34 with minimal congestion; and
removal of vehicles 16 from a particular vehicle care device 34 with minimal congestion.

Here, the particular advantage is that the sequence of processing of vehicle care instructions and, alternatively or additionally, the scope of a particular vehicle care instruction is changeable by means of the control device 50, so as to enable the most efficient possible processing of the vehicle care instructions. The system 10 and the method executable therewith are thus highly versatile and adaptable.

For example, delays in the processing of vehicle care instructions can thus be avoided. Delays can result for example due to a cleaning duration with employment of an operator 44 at an interior cleaning device 40, wherein the cleaning duration takes more time than scheduled. Delays can also arise for example as a result of faults of a vehicle care device 34. Delays can also arise for example if an operator 44 is unavailable, for example is not available to bring a vehicle 16 to a vehicle care device 34 or to perform an interior cleaning at an interior cleaning device 40.

Alternatively or additionally, fluctuations in the number of vehicles 16 requiring care at a vehicle care device 34 and times when there is a high demand for vehicles 16, in particular at peak times, may be encountered. A high number of vehicles 16 requiring care, for example on account of a large number of vehicles 16 being returned within a short space of time or on account of a high demand for vehicles 16 at peak times may likewise make it necessary to automatically change the sequence of processing of the vehicle care instructions and/or the scopes of individual or all vehicle care instructions by the control device 50.

In order to optimize the progress of the vehicle care in the system 10, the control device 50, depending on information that is automatically determinable by the control device 50 or that is suppliable thereto, can determine or modify at least one of the following details, beyond the determination or modification of the sequence of processing of the vehicle care instructions and/or the scopes of the vehicle care instructions:
times for the processing of vehicle care instructions;
allocation of a particular vehicle care instruction to a specific vehicle care device 34 with regard to optimized capacity utilization and under consideration of any servicing or maintenance periods or faults of a vehicle care device 34.

For example, it is possible to alter a cleaning instruction, differing from the ascertained cleaning need, and thus to adapt the scope of the vehicle care instruction. For example, if a large number of vehicles 16 are returned within a short space of time or are rented within a short space of time, merely a basic cleaning is performed by the vehicle washing facilities 38 or at the interior cleaning devices 40, differing from the previously determined cleaning need. Conversely, if there is sufficient time and low demand, cleaning can be performed by the vehicle washing facilities 38 or at the interior cleaning devices 40 with the objective of attaining maximum cleaning performance, differing from the cleaning instruction.

The above-mentioned information, on the basis of which the sequence of processing, the scope, the time and/or the allocation of vehicle care instructions to a vehicle care device 34 can be determined or changed by the control device 50, is or comprises preferably at least one of the following:
details regarding the nature of a vehicle 16 as user-guided vehicle 20 or non-user-guided vehicle 18;
anticipated and/or actual time of arrival of a vehicle 16 at the vehicle rental location 12;
anticipated and/or actual time of arrival of a vehicle 16 at a vehicle care device 34;
anticipated and/or actual number of vehicles 16 requiring care;
anticipated and/or actual duration of the processing of a vehicle care instruction at a vehicle care device 34;
capacity utilization of the vehicle care devices 34;
day of the week of scheduled or performed vehicle care, wherein the scope of the vehicle care instructions at peak times is preferably reducible;
time of day of scheduled or performed vehicle care, wherein the scope of the vehicle care instructions at peak times is preferably reducible;
holiday times or non-holiday times;
requirements with regard to the working hours of operator staff 44, wherein the care of user-guided vehicles 20 is preferably performable during the day and the care of non-user-guided vehicles 18 is also performable at night-time, and/or wherein preferably a vehicle care device 34 that employs an operator 44 (for example an interior cleaning device 40) is used during the day and an autonomous vehicle care device 34 is also usable at night-time;
requirements with regard to operating times of the vehicle care device 34, for example with regard to noise protection;
costs for energy and consumables, in particular water, which are necessary for the operation of the vehicle care device 34, wherein the vehicle care is preferably performed at times when the costs are lower;
information regarding notifications during the processing of vehicle care instructions, which notifications are transmitted to the control device 50 from a vehicle care device 34 or from an operator 44 to the vehicle care device 34;
information regarding any servicing or maintenance times or faults of a vehicle care device 34;
information regarding any disruptions to, or limitations of the public transport network;
information regarding strikes by operator staff 44.

When processing the vehicle care instructions, vehicles 16, as explained above, are brought to a vehicle care device 34 in a non-user-guided manner, in a user-guided manner, or by means of the transport device 58. In the case of an autonomous vehicle care device 34, an autonomous cleaning and/or refueling of the vehicles 16 can be performed. For this purpose, the control device 50 can send information regarding a vehicle care instruction, for example by means of the planning unit 66, to a particular control unit 68 of a vehicle care device 34.

The start of the vehicle care can be actuated for example by the planning unit 66 under control of the control unit 68.

A particular control unit 68 can be part of the control device 50, which for example is arranged spatially separately from the vehicle control unit 54 and the planning unit 66.

A particular control unit 68 can transmit the status of the vehicle care to the control device 50 and in particular planning unit 66 thereof, so as to inform this of the progress of the vehicle care. In particular, the completion of the vehicle care is transmitted to the control device 50.

If vehicle care is performed with employment of an operator 44, it can be provided that information relating to a vehicle care instruction is transmitted from the planning unit 66 to a particular control unit 68 of a vehicle care device 34, and the operator 44 starts the vehicle care.

Alternatively, the operator 44 can be provided with information relating to the vehicle care instruction for example on a data processing apparatus 56, which vehicle care instruction can be started by the operator 44.

Status information and the completion of the vehicle care can be transmitted from the operator 44 by means of the data processing apparatus 56 to the control device 50 and in particular the planning unit 66 thereof, or, as explained above, by means of the control unit 68.

### LIST OF REFERENCE NUMERALS

10 system
12 vehicle rental location
14 area
16 vehicle
18 non-user-guided vehicle
20 user-guided vehicle
22 autonomous vehicle
24 remote-controllable vehicle
26 transfer device
28 transfer device
30 parking device
32 parking space
34 vehicle care device
36 device for vehicle cleaning
38 vehicle washing facility
40 interior cleaning device
42 refueling device
44 operator
48 cleaning tool
50 control device
52 cloud
54 vehicle control unit
56 data processing apparatus
58 transport device
60 detection device
62 sensor element
64 recording device
66 planning unit
68 control unit

1. A system for vehicle care comprising at least one vehicle care device and a control device, wherein vehicles are movable to the at least one vehicle care device and are removable therefrom, and the control device is configured for communication with non-user-guided vehicles, wherein there is storable in the control device associated with a particular vehicle at least one vehicle care instruction comprising information about the care of the vehicle, and the vehicles are treatable at the at least one vehicle care device according to the at least one vehicle care instruction, and wherein at least one of a sequence of processing of vehicle care instructions and a scope of the vehicle care stored in at least one vehicle care instruction is changeable by the control device.

2. The system in accordance with claim 1, wherein a plurality of vehicle care devices is provided, wherein vehicles are associable with more than one vehicle care instruction for care at a corresponding vehicle care device.

3. The system in accordance with claim 1, wherein at least one of a sequence of processing of a plurality of vehicle care instructions associated with a vehicle and the sequence of processing of vehicle care instructions associated with different vehicles is changeable by the control device.

4. The system in accordance with claim 1, wherein the sequence of processing of vehicle care instructions is changeable by an operator of the system by means of a data processing apparatus.

5. The system in accordance with claim 1, wherein the sequence of processing of vehicle care instructions is definable by at least one of the control device and an operator of the system.

6. The system in accordance with claim 1, wherein a scope of the vehicle care stored in at least one vehicle care instruction is changeable by an operator of the system.

7. The system in accordance with claim 1, wherein at least one device for vehicle cleaning is provided as vehicle care device.

8. The system in accordance with claim 7, wherein the device for vehicle cleaning is or comprises a vehicle washing facility.

9. The system in accordance with claim 7, wherein the device for vehicle cleaning is or comprises an interior cleaning device for cleaning a vehicle interior.

10. The system in accordance with claim 1, wherein the device for vehicle cleaning has at least one cleaning tool managed by an operator, or such a tool is arranged on said device.

11. The system in accordance with claim 1, wherein a device for at least one of replenishing, changing and draining an operating material or replacement part of the vehicle is provided as vehicle care device, a refueling device for the vehicle, a charging device, or a replacing device for a vehicle battery.

12. The system in accordance with claim 1, wherein at least one vehicle care device is configured to provide autonomous care for the vehicle, at least in part.

13. The system in accordance with claim 1, wherein at least one vehicle care device is configured in such a way that vehicle care is provided at least in part with employment of an operator.

14. The system in accordance with claim 1, wherein at least one of the sequence of processing of the vehicle care instructions and the scope of vehicle care instructions at least at one vehicle care device is determined or changed by the control device with regard to achieving a high throughput of vehicles.

15. The system in accordance with claim 1, wherein at least one of the sequence of processing of vehicle care instructions and the scope of vehicle care instructions at least at one vehicle care device is determined or changed by the control device with regard to achieving at least one of the following:
short waiting time for a vehicle at the vehicle care device before receiving the vehicle care;
bringing vehicles to the vehicle care device with minimal congestion;
removal of vehicles from the vehicle care device with minimal congestion.

16. The system in accordance with claim 1, wherein at least one of the sequence of processing of the vehicle care instructions and the scope of the vehicle care stored in a vehicle care instruction is determined or changed by the control device on the basis of the vehicle care instruction in respect of the result of the vehicle care.

17. The system in accordance with claim 1, wherein at least one of the sequence of processing of the vehicle care instructions, the scope of the vehicle care stored in a vehicle care instruction, times of processing of vehicle care instructions and the allocation of a particular vehicle care instruction to a specific vehicle care device is determinable or changeable by the control device depending on information that is suppliable to the control device or that is determinable thereby automatically.

18. The system in accordance with claim 17, wherein the information is or comprises at least one of the following:
details regarding the nature of the vehicle as user-guided vehicle or non-user-guided vehicle;
anticipated or actual time of arrival of a vehicle at a facility having the system;
anticipated or actual time of arrival of a vehicle at the at least one vehicle care device;
anticipated or actual number of vehicles requiring care;
anticipated or actual duration of the processing of a vehicle care instruction at the at least one vehicle care device;
capacity utilization of the at least one vehicle care device;
day of the week of scheduled or performed vehicle care, wherein the scope of the vehicle care instructions at peak times is reducible;
time of day of scheduled or performed vehicle care, wherein the scope of the vehicle care instructions at peak times is reducible;
holiday times or non-holiday times;
requirements with regard to the working hours of operator staff, wherein the care of user-guided vehicles is performable during the day and the care of non-user-guided vehicles is also performable at night-time;
requirements with regard to the working hours of operator staff, wherein a vehicle care device that employs an operator is usable during the day and an autonomous vehicle care device is also usable at night-time;
requirements with regard to operating times of the at least one vehicle care device, for example with regard to noise protection;
costs for energy and consumables which are necessary for the operation of the at least one vehicle care device, wherein the vehicle care is preferably performed at times when the costs are lower;
information regarding any servicing or maintenance times or faults of the at least one vehicle care device;
information regarding any disruptions to, or limitations of the public transport network; and
information regarding strikes or any other absences of operator staff of vehicles or the at least one vehicle care device.

19. The system in accordance with claim 1, wherein a device for vehicle cleaning is provided as vehicle care device, and wherein at least one of the sequence of processing of the vehicle care instructions and the vehicle cleaning extent is determined with regard to achieving a basic or fundamental cleaning of the vehicles or with regard to achieving a maximum cleaning performance.

20. The system in accordance with claim 1, wherein a device for vehicle cleaning is provided as vehicle care device, and wherein a cleaning need for the vehicle is determinable with regard to storing the vehicle cleaning extent in the vehicle care instruction for need-based cleaning of the vehicle.

21. The system in accordance with claim 20, wherein the system has a recording device for vehicles, and wherein the cleaning need is determinable by the control device depending on a signal of the recording device.

22. The system in accordance with claim 20, wherein the cleaning need is determinable by the control device depending on at least one of the following:
actual dirty state;
vehicle type;
vehicle age;
time since the vehicle was last cleaned;
distance travelled since the vehicle was last cleaned;
weather at the location of use or return of the vehicle;
or, in the case of rental vehicles,
weather at the location of rental of the vehicle;
road conditions at the location of use, rental or return of the vehicle;
previous rental duration;
next scheduled rental duration;
last vehicle renter;
next vehicle renter;
status of the last or next vehicle renter as preferred or less preferred customer.

23. The system in accordance with claim 20, wherein the cleaning need is determinable by an operator and is transmittable to the control device by means of a data processing apparatus.

24. The system in accordance with claim 20, wherein the vehicle care instruction comprises the information that cleaning is not necessary if no sufficient need for this is demonstrable or if the establishment of a vehicle care instruction lapses in this case.

25. The system in accordance with claim 1, wherein the control device is configured for communication with autonomous vehicles, wherein these are movable under control by the control device and/or information is transmittable from the control device to the autonomous vehicles.

26. The system in accordance with claim 1, wherein the control device is configured for communication with remote-controllable vehicles, wherein these are movable under control by the control device and/or information is transmittable from the control device to the remote-controllable vehicles.

27. The system in accordance with claim 1, wherein the system has data-processing apparatuses for operator staff by means of which non-user-guided vehicles can be guided by the operator.

28. The system in accordance with claim 1, wherein the control device is configured for communication with external data-processing apparatuses managed by operator staff or arranged in the vehicles in order to transmit instructions for executing the vehicle care instructions with employment of an operator.

29. The system in accordance with claim 1, wherein the system has at least one transport device, by means of which a vehicle is at least one of movable to and collectable from at least one vehicle care device, wherein the at least one transport device is in communication with the control device and is controllable thereby.

30. The system in accordance with claim 1, wherein the system comprises a detection device coupled to the control device for determining a vehicle position.

31. The system in accordance with claim 30, wherein the detection device has sensor elements for detecting the vehicles.

32. The system in accordance with claim 31, wherein the sensor elements:
are or comprise cameras, by means of which at least one of the vehicles, the registration numbers thereof and other characterizing elements comprised by the vehicles are optically detectable; and/or
are or comprise wireless elements for locating vehicles by means of a wireless connection, for example by means of RFID technology or Bluetooth technology.

33. The system in accordance with claim 30, wherein at least one of the detection device and the control device is in communication with position-determining elements arranged in the vehicles.

34. The system in accordance with claim 1, wherein the control device comprises a vehicle control unit and a planning unit, wherein the vehicle control unit is configured for communication with non-user-guided vehicles and vehicle care instructions are configured to be coordinated by the planning unit, wherein the planning unit is in communication with at least one control unit, which is associated with the at least one vehicle care device or is comprised thereby, in order to transmit vehicle care instructions to the at least one control unit and/or to receive status notifications regarding the at least one vehicle care device by the at least one control unit.

35. The system in accordance with claim 1, wherein a central control device or a spatially distributed control device having a plurality of data processing units is provided.

36. The system in accordance with claim 1, wherein a report about at least one of scheduled and processed vehicle care instructions is establishable by the control device.

37. The system in accordance with claim 1, wherein at least one transfer device for receiving of the vehicle by the system from a vehicle user and/or for transfer of the vehicle from the system to a vehicle user is provided.

38. The system in accordance with claim 1, wherein an area in which there are arranged at least the at least one vehicle care device and parking spaces for vehicles for the temporary parking of vehicles is provided.

39. A method for vehicle care using a system for vehicle care in which method at least one vehicle care instruction associated with a particular vehicle and comprising information about the care of a vehicle is storable in the control device, and the vehicles are brought to the at least one vehicle care device depending on the at least one vehicle care instruction, receive care at said vehicle care device in accordance with the vehicle care instruction, and are removed from said vehicle care device, and wherein at least one of the sequence of processing of vehicle care instructions and the scope of the vehicle care stored in at least one vehicle care instruction is changeable by the control device.
